(19) United States
(12) Patent Application Publication
(10) Pub. No.: US 2009/0017905 A1
(43) Pub. Date: Jan. 15, 2009

(54) SYSTEM AND METHOD FOR ONLINE POOL WAGERING

(75) Inventors: Shalom Meckenzie, Rishon Le Zion (IL); Avi Shemesh, Rishon Le Zion (IL)

Correspondence Address: Professional Patent Solutions, P.O. BOX 654, HERZELIYA PITUACH, 46105, IL

(73) Assignee: Network LTD

(21) Appl. No.: 12/170,461

(22) Filed: Jul. 10, 2008

Related U.S. Application Data
(60) Provisional application No. 60/948,697, filed on Jul. 10, 2007.

(51) Int. Cl. G06F 17/00

(52) U.S. Cl. 463/26; 463/25; 463/42

(57) ABSTRACT

Disclosed is a method and system for online pool wagering wherein a first user may be provided with a representation of a ticket submitted by at least a second user. The system may include software modules operative to provide a user with wager distribution statistics.

### FIELD OF THE INVENTION

The present invention relates generally to the field of online betting. More specifically, the present invention relates to a method and system for facilitating online, pool wagering.

### BACKGROUND

A betting pool, sports lottery, or office pool if done at work, is a form of gambling where gamblers pay a fixed price into a pool and make a selection on some outcome, usually related to sport. The pool is evenly divided between those that have made the correct selection. There are no odds involved, each winner's payoff depends simply on the number of participating tickets and the number of winners. Additionally, in an informal game the vig (“house take”) is usually quite small or non-existent.

Contestants predict the outcome of sporting events that take place at a later time. The concept was introduced in 1923 by Littlewoods Pools where it was known as toto and based on soccer matches. Today in England, sports lotteries are more commonly referred to as a football pools (see below). American sports lotteries often do not require contestants to purchase a lottery ticket or make an initial wager.

Football pools, often referred to as “The Pools”, are football betting pool based on predicting the outcome of male association football matches set to take place in the coming week.

British Pools—Several different companies such as Littlewoods, Vernons, Zetters and Brittens have organized similar games, the most famous of which was historically known as Treble Chance. Competitors were given a list of football matches set to take place over the coming week, and attempted to pick a line of eight of them whose results would be worth most points by the scoring scheme, traditionally by crossing specific boxes on a printed coupon. A proportion of the players' combined entry fees was distributed among the competitors whose entries were worth the highest scores.

Entries—Entries were traditionally entered by post or via members of the public acting as Agents or Collectors. Collectors walked a route door to door, delivering forms and cash to a central office, taking a percentage usually 12.5% of the money as a fee. Legally they were agents of the entrants, not the pools company. There have been a few cases whereby a rogue Agent has fraudulently withheld players' stake money, even though one entrant had actually chosen a set of jackpot-winning fixtures. These days, Internet applications are also accepted.

Business for Collectors was drummed up by “canvassing”, where a team of company agents knocked on doors in an area of a town or housing estate.

Scoring—Scoring schemes varied over the years. The current Treble Chance games use a scoring scheme which awards three points to score draws (matches where both team scored the same, strictly positive, number of goals), two points to no-score draws (matches where neither team scored a goal) and one point to both home wins (matches where the home team scored more goals than the away team) and away wins (matches where the away team scored more goals than the home team). The most famous historical scoring scheme differentiated between home wins and away wins, awarding one and a half points for games resulting in away wins. A scoring scheme used for only one year split score draws into two categories, awarding three points only for matches ending 1-1 and two and a half points for higher-scoring score draws.

The total score of each line would be calculated, up to a maximum of 24 points. The highest scoring line achieved by any player in that particular week's competition would be declared to be worth the top dividend, with a large proportion of the prize pool awarded to the players responsible for submitting the highest-scoring lines. Large football pools would award second and subsequent dividends, splitting smaller proportions of the prize pool among players who had submitted lines scoring nearly as many points; at its peak, the Littlewoods Treble Chance game would offer up to six dividends.

During the summer, when football leagues were not in operation in the United Kingdom, competitions were based on the results of football matches taking place in Australia. Matches which were postponed would often have their results adjudicated, for the sake of the football pools results, by a board known as the Pools Panel; The Times reports that the Pools Panel was formed in 1963 when a particularly cold winter scrapped football for three weeks running. Panel members included retired footballers with international experience and retired referees.

Results—Before their popularity dwindled, pools results were published in most national newspapers a day or two after the Saturday on which the matches were played. Grids marking the point's totals per game were sometimes published, against which your pools coupon could be aligned to read off the scores.

The BBC television program Grandstand used to broadcast the winning match numbers and any Pools Panel verdicts as part of its Final Score segment in the late afternoon. Remarkably, only two people have so far announced the classified football results on the program since its inception in 1958—Len Martin until his death in 1995 and, since then, Tim Gudgin.

With scores being read out on radio and television it was also common to relay the message “claims by telegram” for days when a few draws occurred (with correspondingly few winners), through “claims by registered mail only” for days when more winners were expected, to “no claims” when there were likely to be so many claimants that the mail would have been overwhelmed.

Winning—Typically a fraction of a penny would be charged for each line entered, though players often had the option to play each line at a higher stake and so receive a higher share of the pool should their line prove a winner. Accordingly, players would usually submit many different lines in a single entry. Popular ways to do this were “full perm” entries, where 10 (or 11, or more) matches were selected and every possible combination of eight matches selected from the ten (etc.) was entered as a single line. As there are C(10,8)=45 ways to select eight matches from ten, the cost of such an entry was 45 times the cost of entering a single line. Note that the term “perm” was used despite the relevant mathematical operation being combination rather than permutation, as the order in which the eight matches were selected was irrelevant. The pools companies, many daily newspapers, and the sporting press also issued “plans”, which were subsets of full perms: these enable the punter to cover more matches for the same stake, with the proviso that even if 8 draws were in the selections, they might not all be in a single line of the plan (but well designed plans could give a guarantee something like ‘if the plan hits 8 draws it must win at least a 3rd dividend’).

The largest prizes would be awarded when only one line was entered scoring the maximum number of points; typically this would occur when only eight or nine matches ended in score draws, so only one player would have the line scoring the maximum. These biggest jackpot prizes could be several hundred thousand pounds, sometimes even more than a million. Prizes depended on the number of players and the cost per line, which varied over the years; one winner, Viv Nicholson, gained notoriety by declaring she was going to “spend, spend, spend” after winning GBP 152,319 in 1961. The story of her subsequent divorces, remarriages, extravagance and eventual bankruptcy was eventually made into a musical named after the famous quote.

At the other extreme, payouts of less than a pound were quite common in lower dividends when many entries won. Most “punters” could expect to receive at least one low payout if they played for long enough.

History—Littlewoods football pools was founded in 1923, Vernons in 1925, Zetters in 1933, and Brittens in 1946. The Treble Chance game was also inaugurated in 1946.

The popularity of the Treble Chance game was due to the fact it offered a potential single large jackpot at a time when no other form of gambling in the United Kingdom did; premium bonds were not offered until 1957 and never offered a jackpot which was as high. The popularity of football pools in the UK declined dramatically after the introduction of the National Lottery in 1994, which offered larger jackpots still. Some football pools offer additional ways to win based on scores of football matches at half-time, or football matches in which particularly many goals are scored.

The football pools did not fall under gambling legislation because they claimed to be competitions of skill, rather than chance; however, their rules typically stated that all transactions were “binding in honor only”. Typically, between one quarter and one half the entry fees taken would be returned to the players as prizes. Companies organizing football pools were heavily taxed; in 1991, the level of tax levied was reduced from 40% of turnover to 37½% of turnover. Additionally, from 1975 on, 2½% of the entry fees went to form the Football Trust which distributed money to football throughout the UK, most famously to help clubs redevelop their stadiums in line with the recommendations made by the Taylor Report.

The Littlewoods Football Pools Collection which shows the history of the pools is held by the National Football Museum.

Other games—Other games offered by football pools companies take the form of “8 homes”, “4 draws”, “5 aways” or the like, where lines consisting of a smaller number of matches are selected and a line is deemed to have won if all the selected matches result in home wins, away wins or draws (irrelevant of the size of the draw) respectively. The cost per line is generally higher; because these attract far fewer players, prizes are generally lower. Some football pools companies additionally organized lotteries, betting on lottery results or spot the ball competitions at various points.

Continental European Pools—Similar football pools competitions are frequently known as toto competitions on Continental Europe. While the principle of requiring entrants to predict the results of football matches in advance remains the same, the details are fundamentally different. The name toto derives from totalisator machines which are used to process the pari-mutuel betting involved.

Typically, a list of 13 matches for the coming week will be given. Pools entrants have to select the result of each one, whether it will be a home win, an away win or neither of these, typically by marking each match with either a 1, a 2 or a N (sometimes X). It is possible to enter two or three results for one or more matches, in which case the entry is treated as a number of separate entries for all possible combinations given; marking two possible results for each of five matches and all three possible results for each of four matches will result in submitting 2 * 2 * 2 * 2 * 2 * 3 * 3 * 3 * 3=32 * 81=2592 different entries. All entries submitting 13 correct predictions will be declared to have won the top prize; sometimes, prizes for fewer correct predictions are also awarded.

The Intertoto Cup competition was inaugurated by the football pools companies of central Europe to provide matches for their toto coupons during the summer months.

### SUMMARY OF THE INVENTION

The present invention is a method and system for facilitating online pooled wagering on events. According to some embodiments of the present invention, there may be provided a transaction server adapted to receive wagers relating to the outcome of a series of events (e.g. set of sporting event, outcome of political situations, weather in a given area over a number of days, etc.). According to further embodiments of the present invention, the transaction server may provide to each of a set of users a set of possible wagering options relating to a set of events. The options may be provided in the form of: (1) a webpage containing a pool coupon, (2) a printed form containing the pool coupon, or (3) any other medium known today or to be devised in the future. A user's ticket, comprising selections relating to a given pool coupon may be logged in the transaction server and a server database or data table related to the given pool may be updated accordingly. Once a user selects from all the wager options on a coupon, his ticket may be deemed closed, and the wager may be deemed made.

According to further embodiments of the present invention, the transaction server or another server functionally associated with the transaction server may provide a user with statistics whereas said statistics may relate to real time wagering distributions across the pool events. The wagering distribution statistics may be provided in conjunction with the interactive pool coupon, and according to certain embodiments may be overlaid with data entry fields or buttons on the interactive coupon. Data displayed with the interactive coupon (e.g. wagering distribution, pot size, number of correct selections, etc.) may be updated as wagering statistics change and as results of specific events are determined.

According to further embodiments of the present invention, either the transaction server or another server associated with the transaction server may be adapted to provide a user with a real time representation of other user's participating tickets. According to some embodiments, a user may be able to download representations of several or all other user's tickets. The representations may be certified or may contain certifying information attesting to the authenticity, accuracy and validity of the ticket representation.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flowchart illustrating an exemplary online pool wagering method by which a first user may be provided with a representation of a ticket submitted by at least a second user in accordance with some embodiments of the present invention;

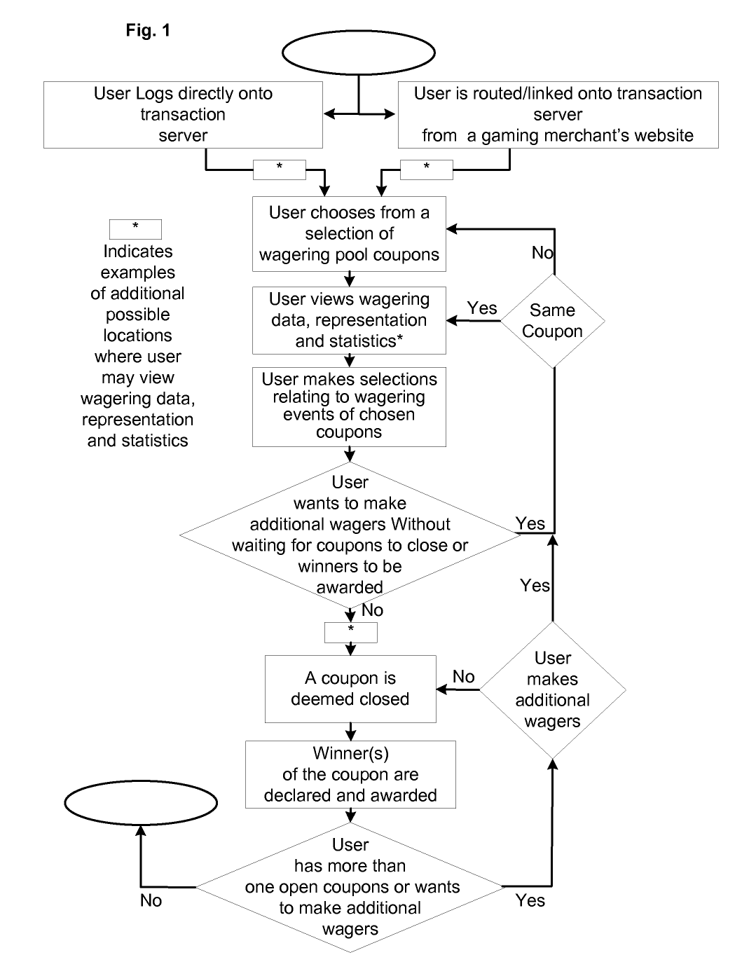

FIG. 2A is a diagram illustrating the main components of an exemplary setup of an online pool wagering system enabling a first user to be provided with a representation of a ticket submitted by at least a second user in accordance with some embodiments of the present invention;

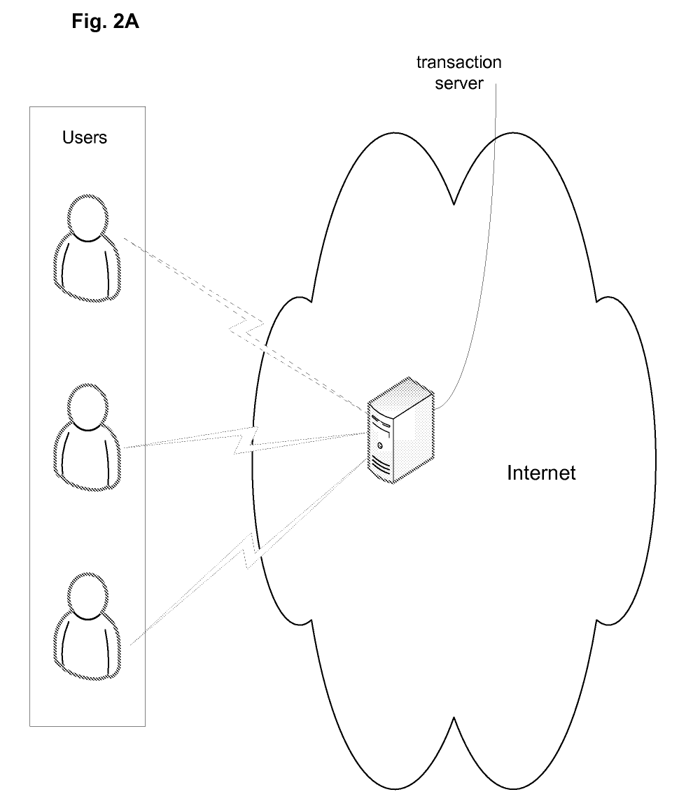

FIG. 2B is a diagram illustrating the main components of an exemplary setup of an online pool wagering system enabling a first user to be provided with a representation of a ticket submitted by at least a second user in accordance with some embodiments of the present invention;

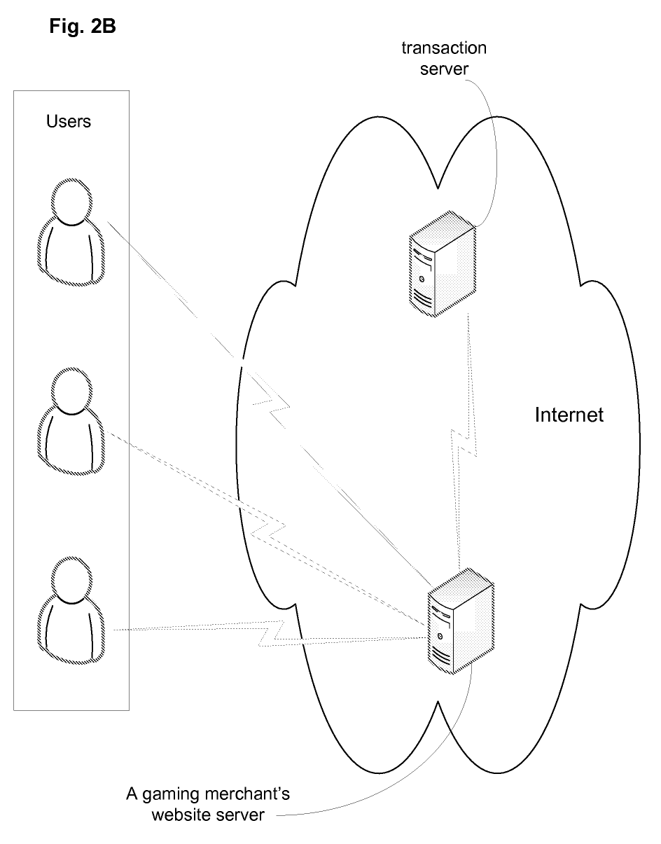

FIG. 3 is a diagram illustrating the main functional building blocks of an exemplary online pool wagering system enabling a first user to be provided with a representation of a ticket submitted by at least a second user in accordance with some embodiments of the present invention;

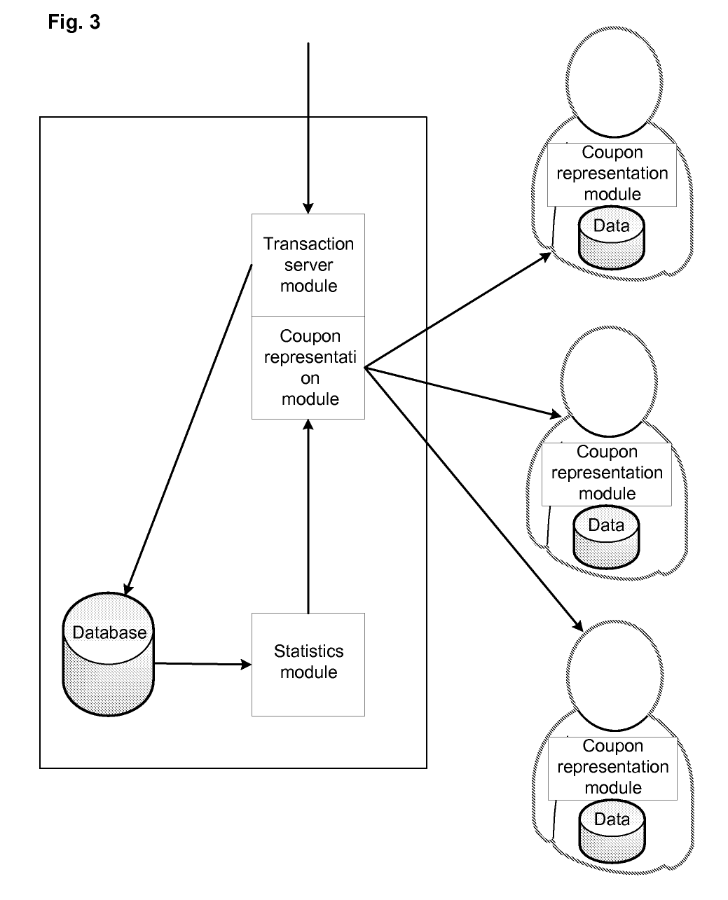

FIG. 4A is a screenshot of an exemplary interactive pool coupon of an online pool wagering system enabling a first user to be provided with a representation of a ticket submitted by at least a second user in accordance with some embodiments of the present invention;

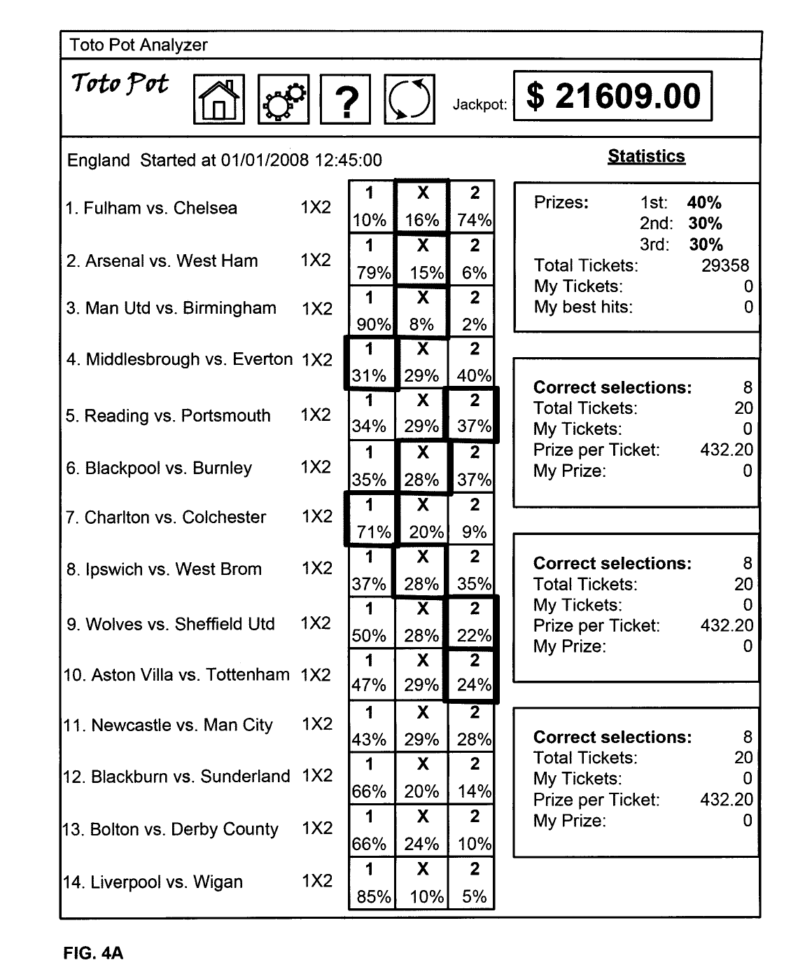

FIG. 4B is a screenshot of an exemplary interactive pool coupon of an online pool wagering system enabling a first user to be provided with a representation of a ticket submitted by at least a second user in accordance with some embodiments of the present invention.

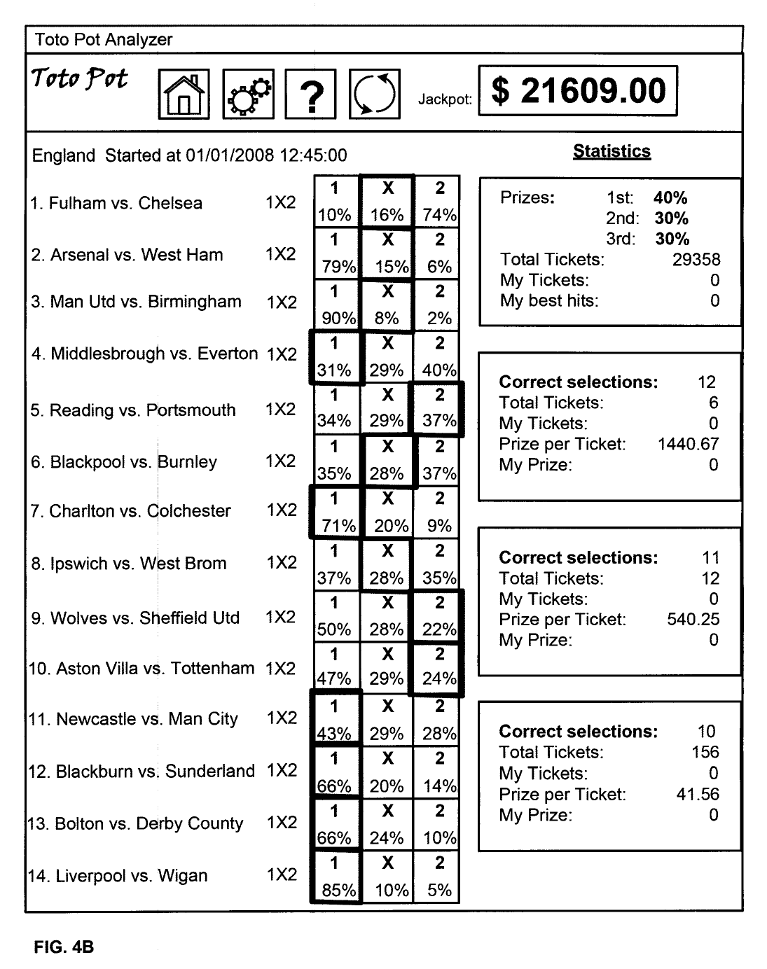

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a method and system for facilitating online pooled wagering on events. According to some embodiments of the present invention, there may be provided a transaction server adapted to receive wagers relating to the outcome of one or a series of events (e.g. set of sporting event, outcome of political situations, weather in a given area over a number of days, etc.). According to further embodiments of the present invention said transaction server may be accessed from a gaming merchant's website directing or else wise linking users to it.

According to further embodiments of the present invention, the transaction server may offer to the user, one or more sets (coupons) of possible wagering options relating to a set of events. The options may be provided in the form of: (1) a webpage containing a pool coupon, (2) a printed form containing the pool coupon, or (3) any other medium known today or to be devised in the future. Said coupons may be offered to all users, or alternatively to a selected group of users which may answer a certain criteria, users may have the option of creating their own customized pool coupons.

According to further embodiments of the present invention a user's selections relating to a given pool coupon may be logged in the transaction server and a server database or data table related to the given pool coupon may be updated accordingly. User's selections may take different formats depending on the type of events waged on, the nature of the bet, the scoring scheme decided upon or other variables. For example, a football game wager selection may be in the form of [team 1 wins; team 2 wins or Draw], [team 1 final score; team 2 final score], [minutes passed from start to first score of match] or any other thinkable football match related parameter or combination of parameters decided upon.

According to some embodiments of the present invention the wager ticket corresponding to a certain coupon may be closed and deemed made, once a user selects from all the wager options on a coupon, once the ticket is submitted or at a differently determined or predetermined time. Upon reaching a certain point in time after which betting odds' statistics might start changing (i.e. starting of a sport event), corresponding pool wager coupon or coupons ,as well as their participating tickets, may be deemed closed. According to further embodiments of the present invention coupon's winner or winners may be declared, upon conclusion of an event or upon receipt of actual results for the last of the coupon's betting events.

Said coupons may be of a “must win” format, wherein no absolute minimum of correct wagers on a submitted ticket is required for winning a prize. (i.e. winner who had the highest number of correct wagers will get the prize, although only a small part of his wagers were correct).

According to further embodiments of the present invention in case of multiple winners, the prize may be equally distributed between winners, may be divided in a way granting earlier submitted tickets owners a larger prize or may be else wise distributed between winners.

According to some embodiments of the present invention, the transaction server or another server functionally associated with the transaction server may provide a user with different data parameters, said data may comprise of, but is not limited to, the following parameters: which active pool coupons is the user or other participants taking part in, which pool coupon tickets are closed and deemed made, wagering distributions, pot sizes, numbers of correct selections, winning tickets, sums of winning prizes, jackpot sums, or any other parameters relating to wagering coupons, said user's tickets or other users' tickets.

According to further embodiments of the present invention, the transaction server or another server functionally associated with the transaction server may provide a user with real time statistics relating to wagering distributions across the pool events. The wagering distribution statistics may be provided in conjunction with the interactive pool coupon, and according to certain embodiments may be overlaid with data entry fields or buttons on the interactive coupon. Data displayed with the interactive coupon (e.g. wagering distribution, pot size, number of correct selections, etc.) may be updated as wagering statistics change and as results of specific events are determined.

According to further embodiments of the present invention, either the transaction server or another server associated with the transaction server may be adapted to provide a user with a representation of other user's closed tickets. According to some embodiments, a user may be able to download representations of several or all other user's tickets.

According to some embodiments of the present invention access of said data parameters, statistics or representations provided to a user, may or may not be limited to a certain user, a certain group of users or to data items relating to pool coupons wagers which the user is currently participating or formally participated in. According to further embodiments of the present invention access of said data parameters, statistics or representations provided to a user may contain certifying information attesting to the authenticity, accuracy and validity of the coupon representation. Said data parameters, statistics or representations may be updated in real-time.

According to further embodiments of the present invention the user application, enabling for a certain participant or user to access other users' data, may be in the form of a downloadable tool. Furthermore said application may calculate the number of tickets with the correct selections and grade them according to their ranking or may simulate events' outcomes thus enabling the user to view the theoretical ranking according to the results they entered.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. An online pool wagering system comprising:
a first module adapted to provide a first user with a representation of a ticket associated with a given coupon submitted by at least a second user.

2. The system according to claim 1, further comprising a second module adapted to provide the first user with wagering distribution statistics for the coupon.

3. The system according to claim 2, wherein said second module is adapted to provide the first user with wagering results for the coupon.

4. The system according to claim 3, wherein said second module is adapted to operate on real-time data.

5. The system according to claim 3, wherein said second module is adapted to operate on simulated data.

6. A method of facilitating online pool betting comprising:
providing a first user with a representation of a ticket associated with a given coupon submitted by at least a second user.

7. The method according to claim 6, further comprising providing the first user with wagering distribution statistics relating to wagers placed by other users on the given coupon.

8. The method according to claim 7, further comprising providing the first user with wagering results for the coupon.

9. The method according to claim 8, wherein wagering results are provided based on real-time data.

10. The method according to claim 8, wherein wagering results are provided based on simulated data.
